(19) United States
(12) Patent Application Publication
(10) Pub. No.: US 2025/0357492 A1
(43) Pub. Date: Nov. 20, 2025

(54) STACKED SECONDARY BATTERY

(71) Applicant: TOYOTA JIDOSHA KABUSHIKI KAISHA, Aichi-ken (JP)

(72) Inventor: Ryuto SAKAMOTO, Okazaki-shi (JP)

(21) Appl. No.: 19/077,063

(22) Filed: Mar. 12, 2025

(30) Foreign Application Priority Data
May 20, 2024 (JP) 2024-082162

(51) Int. Cl. H01M 4/66; H01M 4/02

(52) U.S. Cl. CPC H01M 4/661; H01M 4/663; H01M 2004/027; H01M 2004/028

(57) ABSTRACT

A plurality of units having a structure in which a positive electrode active material layer and a negative electrode active material layer are laminated via an electrolyte layer are arranged between a pair of current collector foils in a lamination direction, and among the pair of current collector foils, a current collector foil opposed to at least an adjacent unit has a conductive protrusion, and is electrically connected to a current collector foil in the adjacent unit via the conductive protrusion.

### CROSS-REFERENCE TO RELATED APPLICATION

This application claims priority to Japanese Patent Application No. 2024-082162 filed on May 20, 2024, incorporated herein by reference in its entirety.

### BACKGROUND

### 1. Technical Field

The present disclosure relates to a stacked secondary battery.

### 2. Description of Related Art

Some stacked secondary batteries include a plurality of units each formed by stacking a positive electrode active material layer, a negative electrode active material layer, and an electrolyte layer (including a separator layer in the case of a liquid electrolyte) between a pair of current collector foils. In this case, adjacent units face each other via the current collector foils. Therefore, in this case, a technique of bonding the current collector foils facing each other is employed to manufacture a stacked secondary battery.

For example, WO 2019/181097 discloses a solid-state battery in which a plurality of solid-state battery cells is stacked. The solid battery cell includes a solid electrolyte layer between a positive electrode active material layer and a negative electrode active material layer. The solid battery cell also includes a positive electrode current collector and a negative electrode current collector. The positive electrode current collector is provided on a surface of the positive electrode active material layer opposite to the surface in contact with the solid electrolyte layer. The negative electrode current collector is provided on a surface of the negative electrode active material layer opposite to the surface in contact with the solid electrolyte layer. In the solid-state battery disclosed in WO 2019/181097, when stacking the solid-state battery cells, the positive electrode current collectors or the negative electrode current collectors of adjacent solid-state battery cells are bonded to each other. In WO 2019/181097, it is indicated that the friction coefficient can be increased by roughening one of the positive electrode current collectors or the negative electrode current collectors to be bonded to each other, suppressing displacement in the stacking position and rotation. In WO 2019/181097, further, it is indicated that a conductive layer (carbon coating layer) having a surface with a large coefficient of friction is arranged when bonding the positive electrode current collectors or the negative electrode current collectors to each other, suppressing displacement in the stacking position and rotation.

Japanese Unexamined Patent Application Publication No. 2021-16878 (JP 2021-16878 A) discloses a stacked secondary battery, in which a large number of current collector foils and current collector terminals are bonded by an ultrasonic bonding method.

### SUMMARY

In the stacked secondary battery in which the current collector foils are bonded to each other, the current collector foils are bonded to each other by a carbon coating layer or an adhesive layer disposed between the current collector foils. When the current collector foils are bonded to each other by the carbon coating layer or the adhesive layer in the stacked secondary battery, however, there is an issue that the interface resistance between the current collector foils increases.

Thus, in view of such an issue in the stacked secondary battery, an object of the present disclosure is to provide a stacked secondary battery capable of suppressing the interface resistance to be low even when current collector foils are bonded to each other via a resin layer.

The present disclosure that achieves the above object includes the following.

<1> A stacked secondary battery including
a plurality of units arranged in a stacking direction, the units each including a structure, in which a positive electrode active material layer and a negative electrode active material layer are stacked via an electrolyte layer, disposed between a pair of current collector foils, in which
at least a current collector foil that faces an adjacent unit, among the current collector foils, includes a conductive protrusion, and is electrically connected to a current collector foil in the adjacent unit via the conductive protrusion.

<2> The stacked secondary battery according to <1>, in which
a first positive electrode active material layer, a first electrolyte layer, a first negative electrode active material layer, a negative electrode current collector foil, a second negative electrode active material layer, a second electrolyte layer, and a second positive electrode active material layer are arranged in this order between the current collector foils of the unit. One of the current collector foils is in contact with the first positive electrode active material layer. The other of the current collector foils is in contact with the second positive electrode active material layer.

<3> The stacked secondary battery according to <1> or <2>, in which
a resin layer is disposed between the adjacent units, and the conductive protrusion penetrates the resin layer.

<4> The stacked secondary battery according to any one of <1> to <3>, in which
the current collector foils each include the conductive protrusion on one surface and a resin layer on the other surface.

<5> The stacked secondary battery according to any one of <1> to <4>, in which
one of the current collector foils includes the conductive protrusion on at least one surface, and the other of the current collector foils includes a resin layer on at least one surface.

<6> The stacked secondary battery according to any one of <3> to <5>, in which
the resin layer contains a carbon-based conductive material.

<7> An electrode stack including
a plurality of units arranged in a stacking direction, the units each including a structure, in which a positive electrode active material layer and a negative electrode active material layer are stacked via an electrolyte layer, disposed between a pair of current collector foils, in which
at least a current collector foil that faces an adjacent unit, among the current collector foils, includes a conductive protrusion, and is electrically connected to a current collector foil in the adjacent unit via the conductive protrusion.

<8> The electrode stack according to <7>, in which
a first positive electrode active material layer, a first electrolyte layer, a first negative electrode active material layer, a negative electrode current collector foil, a second negative electrode active material layer, a second electrolyte layer, and a second positive electrode active material layer are arranged in this order between the current collector foils of the unit. One of the current collector foils is in contact with the first positive electrode active material layer. The other of the current collector foils is in contact with the second positive electrode active material layer.

<9> The electrode stack according to <7> or <8>, in which
a resin layer is disposed between the adjacent units, and the conductive protrusion penetrates the resin layer.

<10> The electrode stack according to any one of <7> to <9>, in which
the current collector foils each include the conductive protrusion on one surface and a resin layer on the other surface.

<11> The electrode stack according to any one of <7> to <10>, in which
one of the current collector foils includes the conductive protrusion on at least one surface, and the other of the current collector foils includes a resin layer on at least one surface.

<12> The electrode stack according to any one of <9> to <11>, in which
the resin layer contains a carbon-based conductive material.

<13> A secondary battery comprising
a positive electrode active material layer, a negative electrode active material layer, an electrolyte layer disposed between the positive electrode active material layer and the negative electrode active material layer, a positive electrode current collector foil connected to the positive electrode active material layer, a negative electrode current collector foil connected to the negative electrode active material layer, a positive electrode terminal connected to the positive electrode current collector foil, and a negative electrode terminal connected to the negative electrode current collector foil, in which
the positive electrode current collector foil and/or the negative electrode current collector foil have a conductive protrusion, and are electrically connected to the positive electrode terminal and/or the negative electrode terminal via the conductive protrusion.

<14> The secondary battery according to <13>, in which a resin layer is disposed between the positive electrode current collector foil and the positive electrode terminal and between the negative electrode current collector foil and the negative electrode terminal, and the conductive protrusion penetrates the resin layer.

<15> The secondary battery according to <13> or <14>, in which the resin layer contains a carbon-based conductive material.

According to the present disclosure, it is possible to suppress the interface resistance to be low even in a stacked secondary battery in which current collectors are bonded to each other via a resin layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view schematically showing a main part of a stacked electrode body in a stacked secondary battery of the present disclosure;

FIG. 2A is a cross-sectional view schematically showing a main part of a current collector foil shown as an embodiment of a stacked secondary battery of the present disclosure;

FIG. 2B is a cross-sectional view schematically showing a main part of an electrode assembly laminated with a current collector foil shown in FIG. 2A;

FIG. 3A is a cross-sectional view schematically showing a main part of a current collector foil shown as another embodiment of the stacked secondary battery of the present disclosure;

FIG. 3B is a cross-sectional view schematically showing a main part of an electrode assembly laminated with a current collector foil shown in FIG. 3A;

FIG. 4A is a cross-sectional view schematically showing a main part of a current collector foil shown as still another embodiment of the stacked secondary battery of the present disclosure;

FIG. 4B is a cross-sectional view schematically showing a main part of an electrode assembly laminated with a current collector foil shown in FIG. 4A;

FIG. 5A is a cross-sectional view schematically showing a current collector foil shown as still another embodiment of a stacked secondary battery according to the present disclosure; and

FIG. 5B is a cross-sectional view schematically showing a main part of an electrode assembly laminated with a current collector foil shown in FIG. 5A.

### DETAILED DESCRIPTION OF EMBODIMENTS

Hereinafter, embodiments of the present disclosure will be described. The description is illustrative of the embodiments and is not intended to limit the scope of the disclosure.

In the present specification, a numerical range indicated by using “to” indicates a range including numerical values described before and after “to” as a minimum value and a maximum value, respectively.

In the numerical ranges described in the present specification in a stepwise manner, the upper limit value or the lower limit value described in one numerical range may be replaced with the upper limit value or the lower limit value of the numerical range described in another stepwise manner. In addition, in the numerical range described in the present specification, the upper limit value or the lower limit value of the numerical range may be replaced with the value shown in the examples.

In the present specification, when an embodiment is described with reference to the drawings, the configuration of the embodiment is not limited to the configuration shown in the drawings. In addition, the sizes of the members in the drawings are conceptual, and the relative relationships of the sizes between the members are not limited thereto.

The stacked secondary battery of the present disclosure has a plurality of units in the stacking direction in which a structure in which a positive electrode active material layer and a negative electrode active material layer are stacked via an electrolyte layer is disposed between a pair of current collector foils. Among the pair of current collector foils, at least a current collector foil opposed to an adjacent unit has a conductive protrusion, and is electrically connected to a current collector foil in the adjacent unit via the conductive protrusion. In the stacked secondary battery of the present disclosure, since the current collector foils in the adjacent units are electrically connected by the conductive protrusion, the interface resistance between the current collector foils can be suppressed to be low.

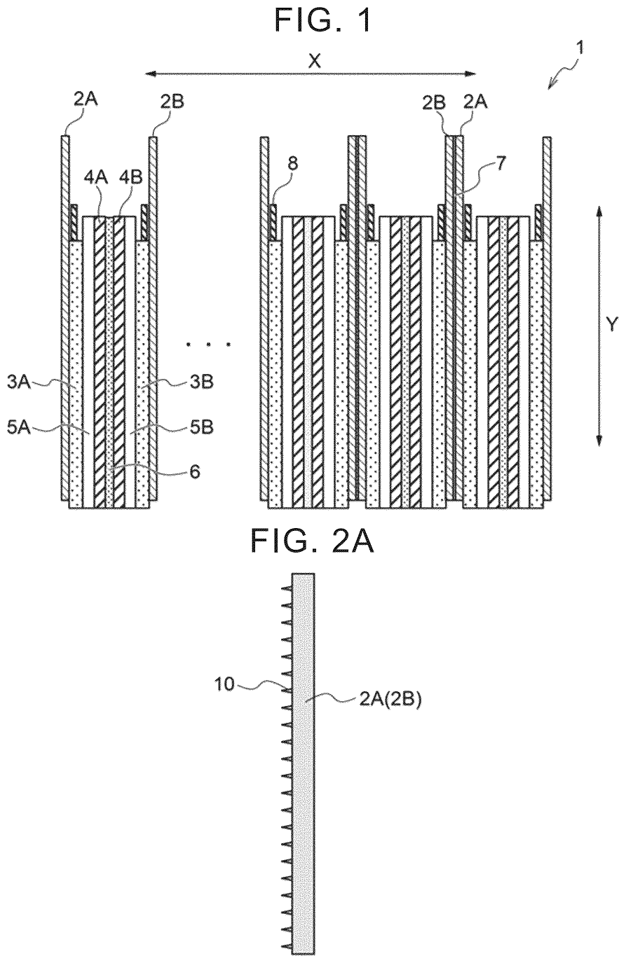

Hereinafter, an embodiment of a stacked secondary battery of the present disclosure will be described with reference to the drawings. As shown in FIG. 1, in a stacked secondary battery 1 shown as an embodiment, a first positive electrode active material layer 3A, a first electrolyte layer 5A, a first negative electrode active material layer 4A, a negative electrode current collector foil 6, a second negative electrode active material layer 4B, a second electrolyte layer 5B, and a second positive electrode active material layer 3B are arranged in this order between a current collector foil 2A and a current collector foil 2B. The pair of current collector foil 2A is in contact with the first positive electrode active material layer 3A, and the current collector foil 2B is in contact with the second positive electrode active material layer 3B. In the stacked secondary battery 1 shown in FIG. 1, the current collector foil 2A and the current collector foil 2B function as a positive electrode current collector.

In the following explanation, the first positive electrode active material layer 3A and the second positive electrode active material layer 3B are collectively referred to as a positive electrode active material layer 3, and members having “A” and “B” denoted by other members are similarly referred to.

In the stacked secondary battery 1, the negative electrode active material layer 4 is provided on both surfaces of the negative electrode current collector foil 6, and each of the negative electrode active material layers 4 faces the positive electrode active material layer 2 via the electrolyte layer 5. Therefore, the stacked secondary battery 1 has two structures in which the positive electrode active material layer 3 and the negative electrode active material layer 4 are laminated between the current collector foil 2A and the current collector foil 2B with the electrolyte layer 5 interposed therebetween. Hereinafter, a current collector foil 2A and a current collector foil 2B, and a laminated structure having two structures in which the positive electrode active material layer 3 and the negative electrode active material layer 4 are laminated between the current collector foil 2A and the current collector foil 2B via the electrolyte layer 5 are referred to as a unit.

The stacked secondary battery 1 includes a plurality of units laminated in the lamination direction (in FIG. 1, the arrow X direction) of the current collector foil 2A and the current collector foil 2B, the positive electrode active material layer 3, the negative electrode active material layer 4, the electrolyte layer 5, and the negative electrode current collector foil 6, and includes a resin layer 7 between the units. The resin layer 7 joins the current collector foil 2A and the current collector foil 2B in the adjacent units, but may be disposed on the outer side (the current collector foil 2A or the current collector foil 2B) of the unit located at both ends of the laminated structure. Further, in the stacked secondary battery 1, the resin layer 7 need not be disposed on the outer side (the current collector foil 2A or the current collector foil 2B) of the unit located at both ends of the laminated structure. In the stacked secondary battery 1, the number of units stacked via the resin layer 7 is not particularly limited, but may be, for example, 10 layers, 20 layers, 30 layers, 40 layers, 50 layers, 60 layers, 70 layers, 80 layers or more.

In the stacked secondary battery 1, the current collector foil 2A and the current collector foil 2B are shaped to extend more than the positive electrode active material layer 3, the negative electrode active material layer 4, the electrolyte layer 5, and the negative electrode current collector foil 6 in a direction perpendicular to the lamination direction (arrow X in FIG. 1) (arrow Y in FIG. 1). The current collector foil 2A and the current collector foil 2B function as a positive electrode current collector. Although not shown in FIG. 1, the current collector foil 2A and the current collector foil 2B are superposed on each other in a stretched part and connected to a positive electrode terminal (not shown). The negative electrode current collector foil 6 is also shaped to be more stretched than the current collector foil 2A and the current collector foil 2B, the positive electrode active material layer 3, the negative electrode active material layer 4, and the electrolyte layer 5 in a direction (arrow Y in FIG. 1) opposite to the direction in which the current collector foil 2A and the current collector foil 2B are stretched. The current collector foil 2A and the current collector foil 2B are superposed on each other in a stretched part and connected to a negative electrode terminal (not shown).

The stacked secondary battery 1 includes a current collector foil 2A that is attached to the positive electrode active material layer 3 and functions as a positive electrode current collector, and an insulating layer 8 that suppresses the current collector foil 2B being short-circuited to the negative electrode active material layer 4, the electrolyte layer 5, and the negative electrode current collector foil 6. The insulating layer 8 covers the negative electrode active material layer 4, the electrolyte layer 5, and the negative electrode current collector foil 6 while the current collector foil 2A and the current collector foil 2B of the respective units are superposed on each other in the stretched part.

### A Positive Electrode Active Material Layer Including

As the positive electrode active material contained in the positive electrode active material layer, a conventionally known material can be used as appropriate. Examples of the positive electrode active material include LiCoO₂, lithium nickel-containing complex oxide, LiMn₂O₄, olivine-type lithium iron phosphate, TiS₂, MnO₂, MoO₃, V₂O₅, and the like. The positive electrode active material may contain any of these compounds alone or may contain a plurality of kinds thereof.

### Negative Electrode Active Material Layer

The negative electrode active material contained in the negative electrode active material layer is not particularly limited, and conventionally known materials can be used as appropriate. Examples of the negative electrode active material include a carbon material. Examples of the carbon material include coke such as petroleum coke, pitch coke, and coal coke; carbon black such as carbides of organic compounds, carbon fibers, and acetylene black; and graphite such as artificial graphite and natural graphite. In addition, as the negative electrode active material, a conductive polymer, lithium titanate, silicon, a silicon compound, or the like can be used. As the negative electrode active material, the above-mentioned materials may be used alone, or a plurality of the above-mentioned materials may be used in combination.

### Negative Electrode Current Collector Foil

A material constituting the negative electrode current collector foil is not particularly limited, and a material conventionally used in manufacturing a negative electrode can be used. The material of the negative electrode current collector foil is not particularly limited, and examples thereof include Cu, Ni, Cr, Au, Pt, Ag, Al, Fe, Ti, Zn, Co and stainless steel, and particularly preferably Cu. As the negative electrode current collector foil, a strip-shaped collector foil having a foil shape, a punched foil shape, a mesh shape, or the like can be used.

### Current Collector Foil and Current Collector Foil

The material constituting the current collector foil and the current collector foil is not particularly limited, and a material conventionally used in the production of a positive electrode can be used. The material of the current collector foil and the current collector foil is not particularly limited, and examples thereof include Cu, Ni, Cr, Au, Pt, Ag, Al, Fe, Ti, Zn, Co and stainless steel, and particularly preferably Al.

### Electrolyte Layer

The electrolyte layer includes a solid electrolyte and/or a liquid electrolyte as an electrolyte. When the electrolyte layer does not include a solid electrolyte and includes a liquid electrolyte, the electrolyte layer may include a separator for suppressing a short circuit between the positive electrode active material layer and the negative electrode active material layer. The solid electrolyte and the liquid electrolyte are not particularly limited, and conventionally known materials can be used as appropriate.

### Resin Layer

The resin constituting the resin layer is not particularly limited, and examples thereof include epoxy resin, acrylic resin, cyanoacrylate resin, polyurethane resin, silicone resin, phenolic resin, polyimide resin, vinyl resin, melamine resin, alkyd resin, and the like. As the adhesive layer, a polyolefin resin and a polyester resin into which a polar group is introduced can also be used.

The resin layer 7 joins the current collector foil 2A and the current collector foil 2B, which are electrically connected by the conductive protrusion. Therefore, the resin layer need not have conductivity, but may contain a conductive material. When the conductive material is included in the resin layer, the interface resistivity between the current collector foil 2A and the current collector foil 2B can be further reduced. The conductive material included in the resin layer 7 is not particularly limited. Examples of the conductive material included in the resin layer 7 include coke such as petroleum coke, pitch coke, and coal coke; carbon black such as carbides of organic compounds, carbon fibers, and acetylene black; and carbon-based conductive materials such as artificial graphite and natural graphite.

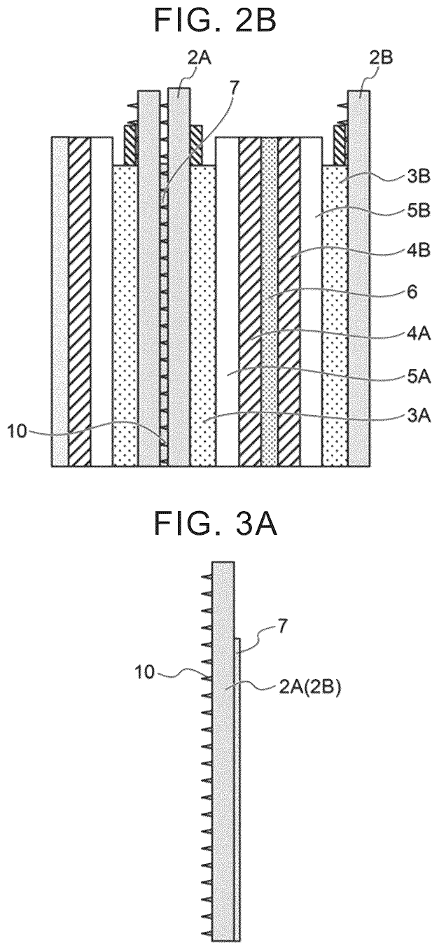

In the stacked secondary battery 1 of the present disclosure, the current collector foil 2A and the current collector foil 2B in the adjacent units are bonded to each other via the resin layer 7, but the current collector foil 2A and the current collector foil 2B are electrically connected to each other by the conductive protrusion. Although the conductive protrusion is not shown in FIG. 1, various embodiments will be described with respect to FIGS. 2A to 5B.

As an embodiment of the present disclosure, as shown in FIG. 2A, there can be mentioned a stacked secondary battery 1 having a conductive protrusion 10 on at least one main surface of a current collector foil 2A and a current collector foil 2B and using the current collector foil 2A and the current collector foil 2B. That is, in the stacked secondary battery 1 shown in FIG. 1, a current collector foil 2A and a current collector foil 2B each having a conductive protrusion 10 on at least one main surface are used. As shown in FIG. 2B, at least one of the current collector foil 2A and the current collector foil 2B of the stacked secondary battery 1 is disposed so that the conductive protrusion 10 faces away from the surface contacting the positive electrode active material layer 3.

With this configuration, in the stacked secondary battery 1 of the present disclosure, it is possible to electrically connect the current collector foil 2A and the current collector foil 2B opposed to each other via the resin layer 7 by the conductive protrusion 10. Here, the conductive protrusion 10 is not particularly limited, and can be produced by a method such as sand blasting treatment, plating treatment, or coating of a resin containing conductive fillers on at least one surface of the current collector foil 2A and the current collector foil 2B. Further, by appropriately setting various conditions in these methods, it is possible to appropriately adjust the height of the conductive protrusion 10, the density in the plane, and the like.

Conductive protrusion 10 in the stacked secondary battery 1 of the present disclosure is disposed between adjacent units, it is preferable to penetrate the resin layer 7 for bonding the current collector foil 2A and the current collector foil 2B. As a result, the conductive protrusion 10 can electrically connect the current collector foil 2A and the current collector foil 2B of the adjacent units. In order for the conductive protrusion 10 to penetrate the resin layer 7, the height of the conductive protrusion 10 may be made larger than the height of the conductive protrusion 10 and the thickness of the resin layer 7. The height of the conductive protrusion 10 may be defined by the surface roughness Rz (referred to as “maximum height”). Here, the surface roughness Rz is a maximum-height roughness conforming to JISB0601 (2013). Specifically, the surface roughness Rz of the surface on which the conductive protrusion 10 is formed in the current collector foil 2A and the current collector foil 2B can be measured using a measuring device: a laser microscope (manufactured by Keyence Corporation, VK-X3000). Surface measurements can be made at any point on the surface and the values obtained in the measurements can be used as the surface roughness Rz. When the surface roughness Rz of the surface of the current collector foil 2A and/or the current collector foil 2B on which the conductive protrusion 10 is formed is larger than the thickness of the resin layer 7, the conductive protrusion 10 penetrates the resin layer 7. The conductive protrusion 10 penetrates through the resin layer 7, so that the current collector foil 2A and the current collector foil 2B of the adjacent units can be electrically connected to each other.

The thickness of the resin layer 7 is preferably smaller than the height (i.e., Rz) of the conductive protrusion 10. The thickness of the resin layer 7 may be, for example, 95% or less of the height (i.e., Rz) of the conductive protrusion 10. The film thickness of the resin layer 7 may be 90% or less of thickness, 85% or less of thickness, 80% or less of thickness, 75% or less of thickness, 70% or less of thickness or 65% or less of thickness. When the upper limit of the film thickness of the resin layer 7 is within this range, the current collector foil 2A and the current collector foil 2B can be electrically and securely connected to each other. Specifically, the thickness of the resin layer 7 is preferably 1 μm to 10 μm, and more preferably 1 μm to 5 μm

In the embodiments shown in FIGS. 2A and 2B, since the conductive protrusion 10 can be electrically connected between the current collector foil 2A and the current collector foil 2B, the resin layer 7 may have conductivity, but need not have conductivity.

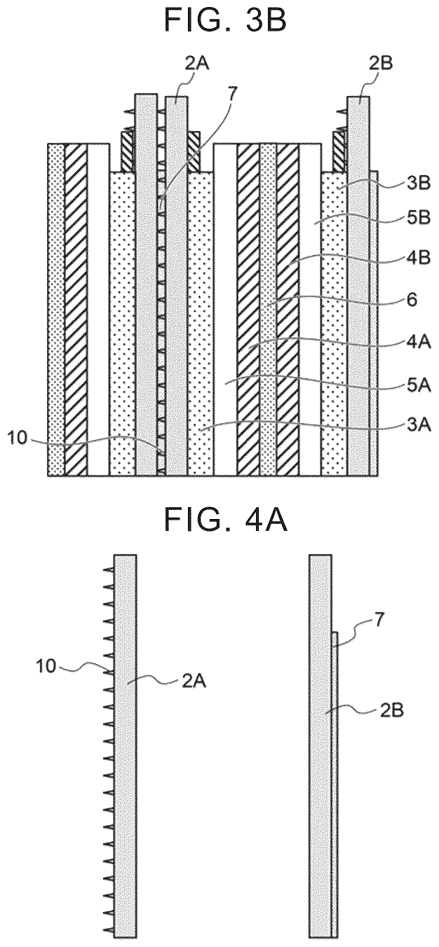

In another embodiment of the present disclosure, as shown in FIG. 3A, the current collector foil 2A and the current collector foil 2B having the conductive protrusion 10 on one main surface are used, and the resin layer 7 is disposed on the other main surface of the current collector foil 2A and the current collector foil 2B in advance. In this case, as shown in FIG. 3B, in the stacked secondary battery 1, the current collector foil 2A is arranged so as to face the conductive protrusion 10 on the side opposite to the surface in contact with the positive electrode active material layer 3, and the current collector foil 2B is arranged so as to face the resin layer 7 on the side opposite to the surface in contact with the positive electrode active material layer 3. By arranging the current collector foil 2A and the current collector foil 2B in this manner, the current collector foil 2A and the current collector foil 2B opposed to each other via the resin layer 7 can be electrically connected to each other by the conductive protrusion 10.

In the embodiments shown in FIGS. 3A and 3B, since the conductive protrusion 10 can be electrically connected between the current collector foil 2A and the current collector foil 2B, the resin layer 7 may have conductivity, but need not have conductivity.

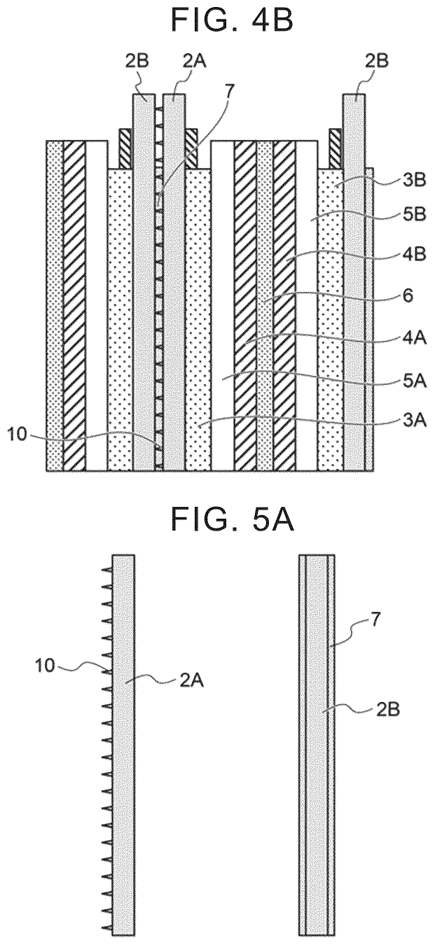

Further, as shown in FIG. 4A, one of the current collector foil 2A and the current collector foil 2B (for convenience, a current collector foil 2A) has a conductive protrusion 10 on at least one main surface. In the present embodiment, the other of the current collector foil 2A and the current collector foil 2B (for convenience, a current collector foil 2B) does not have the conductive protrusion 10, and the resin layer 7 is disposed on at least one surface in advance, as shown in FIG. 4A. Here, as shown in FIG. 4B, the current collector foil 2A having the conductive protrusion 10 is arranged so that the conductive protrusion 10 faces away from the surface contacting the positive electrode active material layer 3. As shown in FIG. 4B, the current collector foil 2B having the resin layer 7 disposed thereon is disposed so that the resin layer 7 faces away from the surface contacting the positive electrode active material layer 3. With this configuration, in the stacked secondary battery 1 of the present disclosure, it is possible to electrically connect the current collector foil 2A and the current collector foil 2B opposed to each other via the resin layer 7 by the conductive protrusion 10.

In the embodiments shown in FIGS. 4A and 4B, since the conductive protrusion 10 can be electrically connected between the current collector foil 2A and the current collector foil 2B, the resin layer 7 may have conductivity, but need not have conductivity.

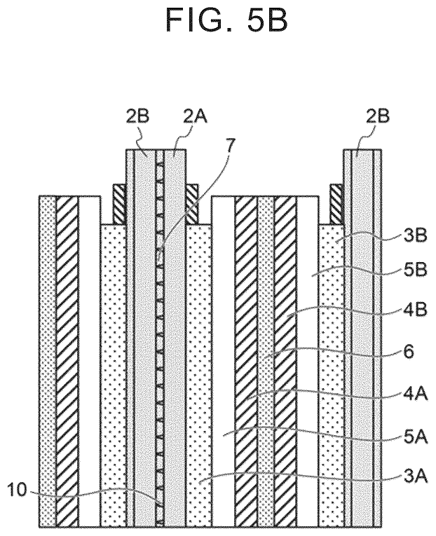

Furthermore, as another embodiment of the present disclosure, as shown in FIG. 5A, one of the current collector foil 2A and the current collector foil 2B (for convenience, a current collector foil 2A) has a conductive protrusion 10 on at least one main surface. In the present embodiment, the other of the current collector foil 2A and the current collector foil 2B (for convenience, the current collector foil 2B) does not have the conductive protrusion 10, and the resin layer 7 is disposed on both surfaces in advance, as shown in FIG. 5A. Here, as shown in FIG. 5B, the current collector foil 2A having the conductive protrusion 10 is arranged so that the conductive protrusion 10 faces away from the surface contacting the positive electrode active material layer 3. The current collector foil 2B having the resin layer 7 disposed on both surfaces thereof can be disposed irrespective of the front and back surfaces thereof. With this configuration, in the stacked secondary battery 1 of the present disclosure, it is possible to electrically connect the current collector foil 2A and the current collector foil 2B opposed to each other via the resin layer 7 by the conductive protrusion 10.

In the embodiments shown in FIGS. 5A and 5B, the conductive protrusion 10 can be electrically connected between the current collector foil 2A and the current collector foil 2B, but the current collector foil 2B having the resin layer 7 disposed on both surfaces thereof needs to be electrically connected to the positive electrode active material layer 3. Therefore, in this case, the resin layer 7 having conductivity is used.

As described above, in the stacked secondary battery 1 of the present disclosure, it is possible to electrically connect the current collector foil 2A in the adjacent units and the current collector foil 2B by the conductive protrusion 10 disposed on at least one surface of the current collector foil 2A and/or the current collector foil 2B. As a result, the interface resistivity between the current collector foil 2A and the current collector foil 2B in the adjacent units can be kept low.

Further, in the stacked secondary battery 1 of the present disclosure, as described above, the current collector foil 2A and the current collector foil 2B are superposed on each other in a stretched part, and are connected to a positive electrode terminal (not shown). At this time, a part where the current collector foil 2A and the current collector foil 2B are contacted with the positive electrode terminal can be electrically connected to each other via the conductive protrusion 10 in the same manner as the configuration shown in FIGS. 2A to 5B. In the stacked secondary battery 1 of the present disclosure, the interface resistance between the current collector foil 2A and the current collector foil 2B in the adjacent units can be suppressed to be low, and the interface resistance between the positive electrode terminal and the current collector foil 2A and the current collector foil 2B can be suppressed to be low.

The stacked secondary battery of the present disclosure is not limited to the stacked secondary battery 1 illustrated in FIGS. 1 to 5B. The stacked secondary battery may include a positive electrode active material layer, a negative electrode active material layer, an electrolyte layer disposed between the positive electrode active material layer and the negative electrode active material layer, a positive electrode current collector foil connected to the positive electrode active material layer, a negative electrode current collector foil connected to the negative electrode active material layer, a positive electrode terminal connected to the positive electrode current collector foil, and a negative electrode terminal connected to the negative electrode current collector foil. The positive electrode current collector foil and/or the negative electrode current collector foil may have the conductive protrusion. The conductive protrusion may be electrically connected to the positive electrode terminal and/or the negative electrode terminal. In this case, the stacked secondary battery of the present disclosure can be electrically connected between the positive electrode current collector foil and the positive electrode terminal and/or between the negative electrode current collector foil and the negative electrode terminal via the conductive protrusion. In this case, in the stacked secondary battery of the present disclosure, the interface resistance between the positive electrode current collector foil and the positive electrode terminal and/or the interface resistance between the negative electrode current collector foil and the negative electrode terminal can be suppressed to be low.

In this embodiment, the positive electrode current collector foil and the positive electrode terminal and/or the negative electrode current collector foil and the negative electrode terminal may be electrically connected to each other by combining the conductive protrusion and the resin layers in the same manner as the configuration shown in FIGS. 2A to 5B. That is, the resin layer may be disposed between the positive electrode current collector foil and the positive electrode terminal and/or between the negative electrode current collector foil and the negative electrode terminal, and the conductive protrusion formed on the positive electrode current collector foil and/or the negative electrode current collector foil may pass through the resin layer.

Hereinafter, the present disclosure will be described in more detail with reference to Examples, but the technical scope of the present disclosure is not limited to the following Examples.

### Example 1

### 1. Production of Stacked Secondary Battery

### 1.1. Preparation of Positive Electrode

First, lithium niobate was coated on positive electrode active material particles (Li_{1.15}Ni_{1/3}Co_{1/3}Mn_{1/3}O₂ main phase particles) in an air atmosphere using a rolling flow type coating device (manufactured by Powrex). The coated positive electrode active material particles were fired under an atmosphere. Thus, positive electrode active material particles having a coating layer of lithium niobate were obtained. Next, polyvinylidene fluoride (PVdF), the positive electrode active material particles, the sulfide solid electrolyte (Li₂S-P₂S₅ glass-ceramics), and a vapor grown carbon fiber (VGCF, manufactured by Resonac Corporation) were added to the polypropylene container. Thereafter, the resulting mixture was stirred for 30 seconds with an ultrasonic dispersing device (UH-50 manufactured by SMT). Next, the container was shaken with a shaker (TTM-1 manufactured by Shibata Scientific Co., Ltd.) for 3 minutes, and further stirred with an ultrasonic dispersing device for 30 seconds. After shaking for 3 minutes on a shaker, the resulting slurry was applied to the aluminum foil by a blade method using an applicator. Thereafter, the resultant was dried naturally and dried on a hot plate at 100° C. for 30 minutes to obtain a positive electrode having a positive electrode active material layer on an aluminum foil.

### 1.2. Preparation of the Negative Electrode

To the polypropylene-made container, PVdF, the negative electrode active material particles (lithium titanate, LTO particles), and the sulfide solid-electrolyte used in the positive electrode were added, and the mixture was stirred with an ultrasonic dispersing device for 30 minutes. The resulting slurry was applied to the copper foil by a blade method using an applicator. Thereafter, the negative electrode was dried naturally and dried on a hot plate at 100° C. for 30 minutes to obtain a negative electrode having a negative electrode active material layer on a copper foil (negative electrode current collector foil). Thereafter, the back surface of the copper foil was similarly coated with a slurry and dried.

### 1.3. Preparation of Electrolyte Layer

To the polypropylene vessel was added heptane, butadiene rubber (BR), and the sulfide solid-electrolyte used in the positive electrode, and the mixture was stirred in an ultrasonic dispersing device for 30 seconds. Next, the container was shaken with a shaker (TTM-1 manufactured by Shibata Scientific Co., Ltd.) for 30 minutes, and further stirred with an ultrasonic dispersing device for 30 seconds. After shaking for 3 minutes on a shaker, the resulting slurry was applied to the aluminum foil by a blade method using an applicator. Thereafter, the film was dried naturally and dried on a hot plate at 100° C. for 30 minutes to form an electrolyte layer containing a solid electrolyte on an aluminum foil as a substrate.

### 1.4. Preparation of Resin Layer

The acetylene black and PVdF of the conductive material were weighed so as to be 20 wt % and 80 wt %, respectively, as a sum of 100 wt %. Then, N-methylpyrrolidone was added to prepare a carbon-coated resin having conductivity. Next, the aluminum foil was coated on one side so as to have a film thickness of 2 μm, and dried at 100° C. for 1 hour to prepare a resin layer having conductivity on the aluminum foil.

### 1.5. Preparation of Electrode Assembly

First, the negative electrode active material layers on both surfaces of the negative electrode prepared in 1.2. were bonded to each other in such a manner that the electrolyte layers prepared in 1.3. were in direct contact with each other, and pressed by 1.6 t/cm. Thereafter, the aluminum foil as a base material was peeled off from the electrolyte layer. Subsequently, the positive electrode active material layer and the electrolyte layer were bonded to each other so as to be in direct contact with each other (double-sided), and pressed with a 1.6 t/cm. Thereafter, the aluminum foil was peeled off and cut so that the positive electrode active material layers became 70 mm×70 mm. Next, an insulating layer made of polyimide was adhered to the positive electrode active material layer. Thereafter, a first current collector foil (a resin layer having conductivity on the aluminum foil obtained in 1.4) was bonded to one positive electrode active material layer. A second current collector foil (roughened nickel foil) was bonded to the other positive electrode active material layer and densified by 5 t/cm. Thereafter, the electrode body was cut into a tab shape to prepare an electrode body. As the roughened nickel foil, a foil having a Rz of 4 μm was used.

### 1.6. Production of Stacked Secondary Battery

Seventy electrode bodies prepared in 1.5. were laminated. The first current collector foil and the second current collector foil extending from one end of the electrode assembly were superimposed on the positive electrode terminal, and were pressed and bonded by 5 MPa at 140° C. Further, the negative electrode current collector foil extending from the other end of the electrode body was superimposed on the negative electrode terminal, and ultrasonic bonding was performed. Thereafter, 70 laminated electrode bodies were laminated and sealed to obtain a stacked secondary battery.

### 1.7. Evaluation

The resistance of the obtained stacked secondary battery was measured. First, CCCV was charged with 2.95 V, 0.3 C and then discharged to 1.5 V. After that, 2.17 V was charged, and CC was discharged by 5 C, and the resistivity was calculated from ΔV.

### Comparative Example 1

Stacked secondary battery was fabricated in the same manner as in Example 1, except that a roughened nickel foil having a Rz of 1 μm was used as the second current collector foil, and the resistivity was measured.

### Comparative Example 2

Except for using a nickel foil having a Rz of 0.1 μm as the second current collector foil, to produce a stacked secondary battery in the same manner as in Example 1, the resistivity was measured.

### Comparative Example 3

Stacked secondary battery was fabricated in the same manner as in Example 1, except that the roughened nickel foil having a Rz of 4 μm was used for the first current collector foil and the second current collector foil, and the resistivity was measured.

### Comparative Example 4

A stacked secondary battery was attempted in the same manner as in Example 1, except that the aluminum foil (without the resin layer) used in the production of the resin layer was used as the first current collector foil, the nickel foil was used as the second current collector foil, and 70 electrode bodies were laminated by ultrasonic bonding.

### Results

Table 1 shows the resistances measured for the stacked secondary battery prepared in Example 1 and Comparative Examples 1 to 3. In Comparative Example 4, a foil cut occurred, and a stacked secondary battery could be produced.

TABLE 1

| | First current collector foil | | Second current collector foil | | | |
|---|---|---|---|---|---|---|
| | Core | | Core | | | Resistance |
| | material | Coat | material | RZ | Coat | mΩ |
| Example 1 | Untreated | Found | To | 4 | None | 12 |
| | Al | | roughen | | | |
| | | | Ni | | | |
| Comparative | Untreated | Found | To | 1 | None | 26 |
| Example 1 | Al | | roughen | | | |
| | | | Ni | | | |
| Comparative | Untreated | Found | Untreated | 0.1 | None | 26 |
| Example 2 | Al | | Ni | | | |
| Comparative | To | None | To | 4 | None | 26 |
| | roughen | | roughen | | | |
| Example 3 | Ni | | Ni | | | |
| Comparative | Al foil | None | Ni foil | | None | Foil |
| Example 4 | | | | | | cutting |

As shown in Table 1, compared with Comparative Example 1 to Comparative Example 3, in the stacked secondary battery manufactured in Example 1, by using the current collector foil having the conductive protrusion formed, between the adjacent electrode bodies are electrically connected, it was possible to suppress the resistance value to low.

### Reference Experimental Example

The roughened nickel foil having a Rz of 4 μm used in Example 1 and the roughened nickel foil having a Rz of 1 μm used in Comparative Example 2 were bonded to the carbon-coated aluminum foil used in Example 1 and the like. Thereafter, the film was mechanically peeled, and the peeled surface of the carbon-coated aluminum foil was observed. As a result, although not shown, when the roughened nickel foil having a Rz of 4 μm used in Example 1 was bonded, it was found that a large number of holes that penetrate through the carbon coat layers and reach the aluminum foil were formed on the peeled surface by the conductive protrusion formed on the roughened nickel foil. On the other hand, when a roughened nickel foil having a Rz of 1 μm was used in Comparative Example 2, no pores were observed that penetrated through the carbon-coated layers and reached the aluminum foil.

What is claimed is:

1. A stacked secondary battery comprising a plurality of units arranged in a stacking direction, the units each including a structure, in which a positive electrode active material layer and a negative electrode active material layer are stacked via an electrolyte layer, disposed between a pair of current collector foils, wherein
at least a current collector foil that faces an adjacent unit, among the current collector foils, includes a conductive protrusion, and is electrically connected to a current collector foil in the adjacent unit via the conductive protrusion.

2. The stacked secondary battery according to claim 1, wherein a first positive electrode active material layer, a first electrolyte layer, a first negative electrode active material layer, a negative electrode current collector foil, a second negative electrode active material layer, a second electrolyte layer, and a second positive electrode active material layer are arranged in this order between the current collector foils of the unit, one of the current collector foils is in contact with the first positive electrode active material layer, and the other of the current collector foils is in contact with the second positive electrode active material layer.

3. The stacked secondary battery according to claim 1, wherein a resin layer is disposed between the adjacent units, and the conductive protrusion penetrates the resin layer.

4. The stacked secondary battery according to claim 1, wherein the current collector foils each include the conductive protrusion on one surface and a resin layer on the other surface.

5. The stacked secondary battery according to claim 1, wherein one of the current collector foils includes the conductive protrusion on at least one surface, and the other of the current collector foils includes a resin layer on at least one surface.
